(19) United States
(12) Patent Application Publication
(10) Pub. No.: US 2008/0014650 A1
(43) Pub. Date: Jan. 17, 2008

(54) Method for Determining Characteristic Numbers for Catalysts

(75) Inventor: Matthias Boll, Koln (DE)

Correspondence Address: NORRIS, MCLAUGHLIN & MARCUS, PA, 875 THIRD AVENUE, 18TH FLOOR, NEW YORK, NY, 10022, US

(73) Assignee: BAYER TECHNOLOGY SERVICES GMBH, LEVERKUSEN (DE)

(21) Appl. No.: 11/574,925

(22) PCT Filed: Aug. 27, 2005
(86) PCT No.: PCT/EP05/09267

§ 371 Date: Mar. 8, 2007

(30) Foreign Application Priority Data
Sep. 9, 2004 (DE) 102004043547.2

(51) Int. Cl. G01N 27/00

(52) U.S. Cl. 436/149

(57) ABSTRACT

The present patent application encompasses a method of determining characteristic numbers for catalyst material by means of electrochemical measurement, the use of this method for optimization and selection of catalysts and processes.

The present patent application encompasses a method of determining characteristic numbers for catalyst material by means of electrochemical measurement, the use of this method for optimization and selection of catalysts and processes.

The testing of catalysts in general, hydrogenation catalysts in particular, to determine selectivity, activity and operating life has hitherto been very time-consuming and expensive. At present reactions are carried out in (single or multiple) reactors, often under a superatmospheric pressure of hydrogen, and the hydrogen consumption and/or the amount of reaction product and reaction by-products per unit time or as a function of time are determined for these tests (for example Hoffer et. al., Catal. Today, 2003, 1-7, 2887). The outlay is very great since high capital costs are incurred for appropriate (experimental) reactors and the employees need to have high qualifications. In addition, large amounts of sample material are required because of the large experimental arrangement and time and money are required for the analysis (HPLC, GC-MS etc.) of each individual measurement point.

Owing to this outlay, many manufacturers of catalysts do not determine characteristic parameters derived from a reaction to characterize their product but instead determine physicochemical parameters which, like the particle size distribution, chemical analysis in respect of the elements and possibly temperature-programmed oxidation with subsequent reduction (TPR/TPO), allow only indirect predictions of the catalytic properties.

The use of an electrochemical cell for observing the poisoning of a catalyst by sulfur compounds is known from the literature, although without mention being made of on-line monitoring of a hydrogenation reaction which proceeds at the same time (L. Horner, C. Franz, Z. Naturforsch. 40b (1985), 814-821). The hydrogenation of acetone over specific Raney nickel hydrogenation catalysts has been examined elsewhere by electrochemical monitoring. (J. Pardillos-Guindet, S. Metais, S. Vidal, J. Court, P. Fouilloux, Applied Catalysis A: General 132 (1995) p. 61-75). A method which gives generally valid information about comparable properties of different catalysts is not known at present.

It is therefore an object of the invention, starting out from the abovementioned prior art, to provide a method which gives very comprehensive information about catalysts to be examined and is at the same time simple and quick to use and can be carried out inexpensively and can thus be used for quality monitoring in the production and use of catalysts or for screening or comparative examination in a catalyst library.

This has surprisingly been achieved by the method of the invention.

The present invention therefore provides a method of determining characteristic numbers for the catalytic behavior of catalyst material, preferably in suspension, in particular for hydrogenation reactions, by determining a potential difference and the fluctuation and/or change in this difference over time between a measurement electrode which dips into a constantly stirred reaction mixture and a reference electrode, with hydrogen being passed continuously through the reaction mixture in the case of a hydrogenation reaction.

The inventive, electrochemical determination, preferably also carried out on-line of measurement parameters for the rapid determination of characteristic numbers for the catalytic behavior of catalyst materials requires only a small outlay in terms of apparatus and is quick and inexpensive. The characteristic numbers which are thus determined in a surprisingly simple way, simultaneously and under standard conditions, provide comparative information about important quality features such as activity, activatability and operating life of a catalyst and can be used in quality assurance in the production and use of the catalyst. In addition, the course of the catalysis in respect of desirable and/or undesirable secondary reactions can be monitored. The method can likewise be used for the rapid determination of possible catalyst poisons and quantification of their influences on the reaction rate. The method is therefore suitable for many catalysts, e.g. oxidation catalysts, polymerization catalysts, depolymerization catalysts and in particular hydrogenation catalysts.

The method of the invention is used for the comparative quality determination of various catalysts, in particular hydrogenation catalysts, under standard conditions to be chosen in each case. As an example of standard conditions according to the invention, a hydrogenation reaction is carried out at a constant pressure in the reaction mixture, preferably atmospheric pressure, at room temperature, i.e. 22° C., and in buffered solution, in particular buffered to pH 7, using disodium maleate as starting material to be hydrogenated, with it being possible to use solvents in which the starting materials to be hydrogenated, in this case maleates, are sufficiently soluble, in this case preferably water. The hydrogenation catalysts to be examined are present as suspensions in the reaction mixture. In the case of other catalytic reactions and/or catalyst systems, standard conditions appropriate to the reactions and systems should be chosen.

The inventive method of determining characteristic numbers of catalysts is characterized in that the potential difference caused by addition of starting material between the power output electrode in the reaction mixture and a reference electrode which is connected in an ion-conducting manner with the reaction mixture is determined electronically as a function of time and a relaxation time which corresponds to the period of time from addition of the starting material to the end of the reaction of the starting material (consumption of the starting material) is thus measured. Thus, for example, the characteristic relaxation time (K1′) for a particular amount of starting material added and/or the gradient (K2′) from the plot of a plurality of relaxation times against the amount of starting material added in each case can according to the invention be correlated with the activity (e.g. hydrogenatability) of a catalyst. The y axis intercept at “amount of available starting material=0” (K3′) can, for example, be correlated with the activatability or the activation time of the catalyst. Finally, the maximum possible amount of starting material to be added (K4′) can, for example, be used as a measure of the operating life. The characteristic numbers K1, K2, K3 and K4 normalized for the amount of catalyst (obtained by division of the measured values K1′, K2′, K3′, K4′ by the amount of catalyst used) are comparable within a class of reactions, for example the class of hydrogenation reactions under standard conditions using hydrogenation catalysts to be varied, and thus allow evaluation of the catalysts in respect of the abovementioned quality features. The correlation of the characteristic numbers with the quality features can, in the case of proportional, antiproportional, exponential or other mathematically describable dependences, describe quantifiable otherwise also purely qualitative dependences.

In the case of hydrogenation reactions, for example, a high or, in the case of a comparison, higher value of K1 and/or K2 is assumed to correspond to a low or lower activity of the catalyst, a high or higher value of K3 is assumed to correspond to a low or lower activatability of the catalyst or a high or higher value of K3 is assumed to correspond to a long or longer activation time of the catalyst and a high or higher value of K4 is assumed to correspond to a long or longer operating life of a catalyst.

The quality features of the catalysts determined under standard conditions make it possible for a person skilled in the art to draw conclusions about the properties of the catalysts under reaction conditions deviating from the standard conditions.

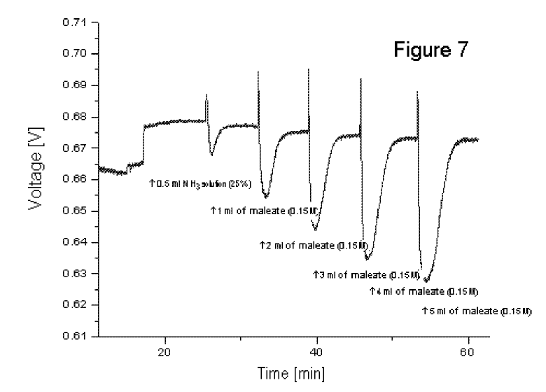

In a preferred embodiment of the method of the invention, a gold sheet as power output electrode is dipped into a stirred suspension of a defined amount of the catalyst to be examined. Various volumes of a disodium maleate solution are subsequently added. The potential difference between the power output electrode and a reference electrode which is connected in an ionically conductive manner with the suspension is measured electronically as a function of time. When the disodium maleate is added, the potential difference changes in a characteristic way and the time, viz. the relaxation time (K1′), which elapses until the potential is once again at a value which is constant over time and is close to the original value, thus indicating the end of the hydrogenation reaction, is determined. As a result of the addition of various volumes of disodium maleate solution, different times which are linearly related, as a function of the amount added, to the volume of disodium maleate solution (provided that the disodium maleate solution has the same concentration in each case) are determined. The gradient and the intercept on the Y axis of the lines, which provide the values K2′ and K3′, can be determined from these results either graphically or mathematically, for example by means of linear regression. The sum of the volumes of disodium maleate solution added before severe noise in the measured potential difference occurs (deactivation of the catalyst) corresponds to the characteristic number K4′. K1′, K2′, K3′ and K4′ are then normalized relative to the amount of catalyst used in the study. This method can also be utilized to study the influence of foreign compounds, especially “catalyst poisons”, on the hydrogenation behavior. Catalyst poisons are used in industry to suppress particular secondary reactions which the catalyst catalyzes under particular reaction conditions, for example the undesirable hydrogenation of the aromatic. The method of the invention enables the effect of various catalyst poisons on the catalyst and any resulting influence on the desired reaction to be examined quickly and inexpensively. The difference between the values K1(unpoisoned) and K1(poisoned) for a particular catalyst, in each case determined by the method described above and in detail for FIG. 7, is determined as a function of a plurality of catalyst poisons and an effectiveness ranking list of the catalyst poisons for individual types of catalyst is determined therefrom. This gives commercial information on the preferred use of the catalyst poisons depending on the application.

Preference is given to a method of determining the abovementioned measurement parameters which uses the potential difference of the measured absolute voltage or any time-average value of the voltage, preferably at least 1 second, particularly preferably at least 2 minutes, very particularly preferably at least 5 minutes, before addition of a reactive starting material relative to the potential minimum after addition of the reactive starting material to the mixture as first measurement parameter and the time difference (relaxation time) between the time at which the starting material is added and the time at which an approximately constant absolute voltage is reached again after the addition of starting material (end of the reaction) is used as second measurement parameter.

Preference is given to a method in which the pH of the reaction mixture is kept constant during the measurement, in particular by use of a buffer solution.

In a particularly preferred method, the pressure in the reaction mixture is kept constant, preferably at atmospheric pressure, and the temperature is likewise kept constant, preferably at room temperature. This leads to a reduction in fluctuations in the measurements.

In a preferred method, the catalyst is present as a solid in a condensed or gaseous phase, preferably in a liquid phase, and is either in timewise limited contact with the power output electrode in a stirred suspension as a result of random impacts against the power output electrode and/or it is connected firmly to the power output electrode and/or the power output electrode is itself made of the catalyst material to be examined.

As catalysts which are subjected to this method, it is possible to use metal catalysts in pure form, in doped form or in alloys and/or mixtures, preferably noble metal and seminoble metal catalysts, particularly preferably palladium, platinum or ruthenium, rhodium, iridium, or transition metal catalysts, preferably iron, cobalt, chromium, nickel or copper, particularly preferably Raney nickel or Raney copper. The metal catalysts are either used in supported form on carbon or silicon oxide or on metal, with the support metal being able to be identical to or different from the catalyst metal, particularly preferably on activated carbon supports, or else in unsupported form.

Preference is given to a method in which a water-soluble organic compound having at least one double bond, preferably an unsaturated dioic acid having a C₂-C₈ carbon chain and/or a salt thereof, particularly preferably maleic acid and/or its disodium salt, is used as starting material.

The general method of measuring electrochemical potentials at, for example, gold power output electrodes or at power output electrodes made of other suitable materials is generally known and is employed (c.f., for example, J. Pardillos-Guindet, J. of Catalysis 155, (1995), pp. 12-20 or U. Kürschner et al, Catalysis Letters 34, (1995), page 191-199).

The reference electrode is usually connected in an electrically conductive manner with the reactor solution, in this case ion-conductively via a salt bridge having a frit, and is located either within or outside the reactor, particularly preferably outside the reactor. The reference electrode should then be independent of the reaction temperature and other influences, for example concentration changes in the reactor, and thus provide a potential which is constant over time. As reference electrode, preference is given to using an electrode of the second type, i.e. a half cell having a defined and constant equilibrium potential, for example a calomel or silver-silver chloride electrode (Argental electrode), particularly preferably a calomel electrode.

Suitable measurement electrodes are electrodes composed of a metal which is inert toward the reactants or a chemically inert alloy or mixture of metals, e.g. stainless steel or a noble metal such as gold, silver or platinum metals, since no further known chemical processes which could influence the potential proceed at these materials. The measurement electrode therefore preferably comprises a chemically inert metal or a chemically inert alloy or mixture of metals, in particular stainless steel, gold, silver, copper or platinum metals such as platinum, palladium, rhodium, ruthenium, osmium or iridium, in the case of a hydrogenation reaction particularly preferably gold, preferably configured as sheet, wire, felt, sponge or mesh.

The method of the invention is also particularly useful for use in high-throughput chemistry, particularly in materials testing or catalyst development.

The method of the invention is therefore also particularly preferably used for the on-line determination of characteristic numbers, for example by use of a pipetting robot for addition of starting materials, automatic data recording by means of a voltage measuring instrument, data transmission to a PC and determination of the above-described characteristic numbers by automated evaluation by means of software and/or in parallelized operation.

Furthermore, the method of the invention is highly suitable for the production of products, in particular in the chemical-pharmaceutical industry, by processes in which catalysts are used, with the catalyst used being selected or optimized according to characteristic numbers determined by the method of the invention.

The method of the invention can also be used in processes for producing catalysts in order to optimize these processes and their products.

Finally, the method of the invention can also be used for selecting a catalyst suitable for a particular purpose from a finite number of available catalysts.

These processes and their products are likewise subject matter of the present patent application.

The invention is illustrated by way of example below with the aid of the figures without being restricted thereto.

In the figures:

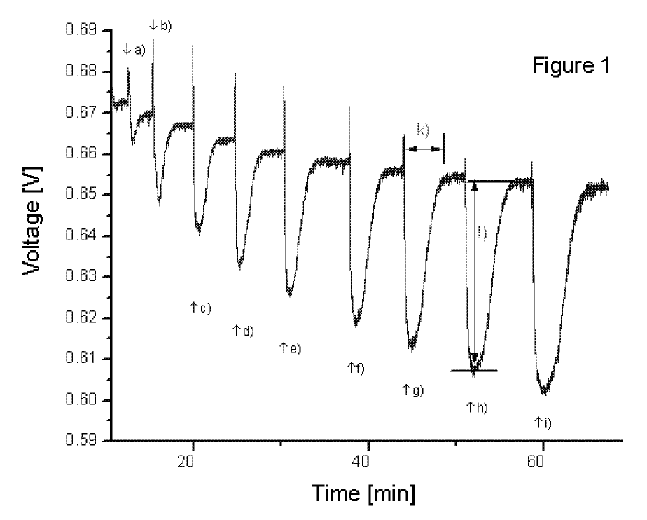

FIG. 1 shows a voltage/time graph for the addition of starting material to a suspension of catalyst A. A potential difference 1) for the addition of 8 ml of starting material and the relaxation time k) for the addition of 7 ml of starting material are indicated by way of example

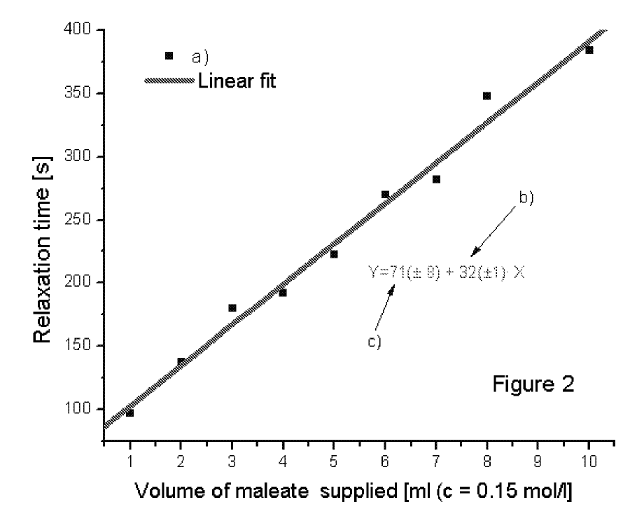

FIG. 2 shows relaxation times for a plurality of starting material additions determined from FIG. 1 as a function of the amount of starting material with linear regression. a) characteristic number K1′: relaxation time at a defined amount of added starting material (e.g. data point (4 ml/192 s), b) characteristic number K2′: gradient of the regression line, c) characteristic number K3′: intercept on the y axis (volume of starting material supplied=0) of the regression line as characteristic numbers for the activity (K1′, K2′) and activatability (K3′) of the catalyst A

Tab. 1 shows the measured values from the voltage/time graph shown in FIG. 2

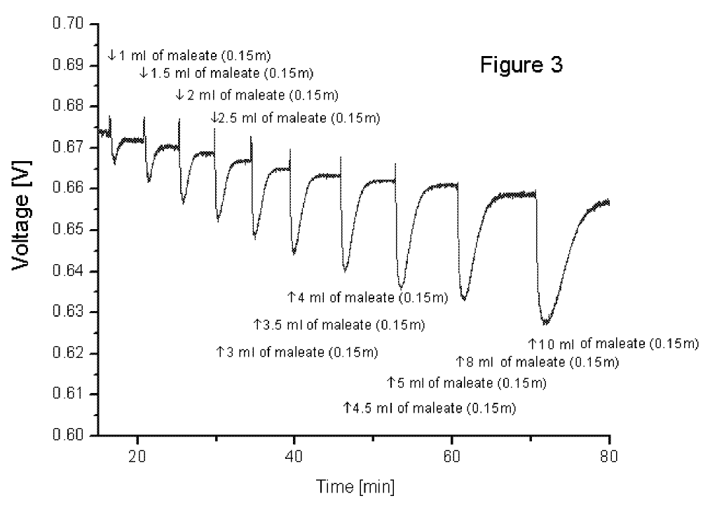

FIG. 3 shows a voltage/time graph for the addition of starting material to a suspension of catalyst B

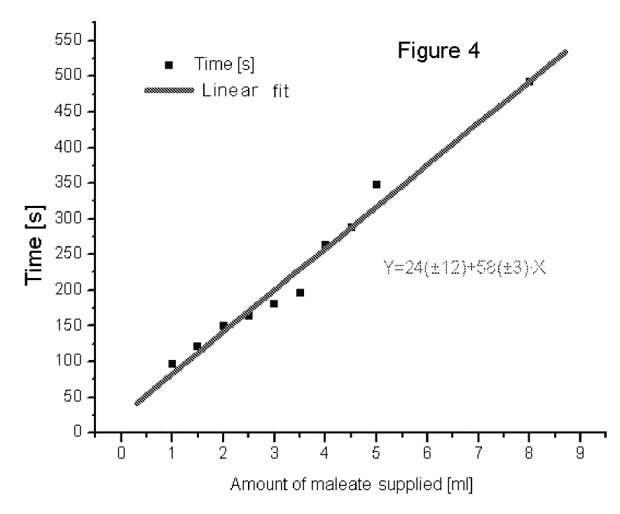

FIG. 4 shows relaxation times for a plurality of starting material additions determined from FIG. 3 as a function of the amount of starting material with linear regression. Characteristic number K2′: gradient of the regression line as characteristic number for the activity of the catalyst B

Tab. 2 shows the measured values from the voltage/time graph shown in FIG. 4

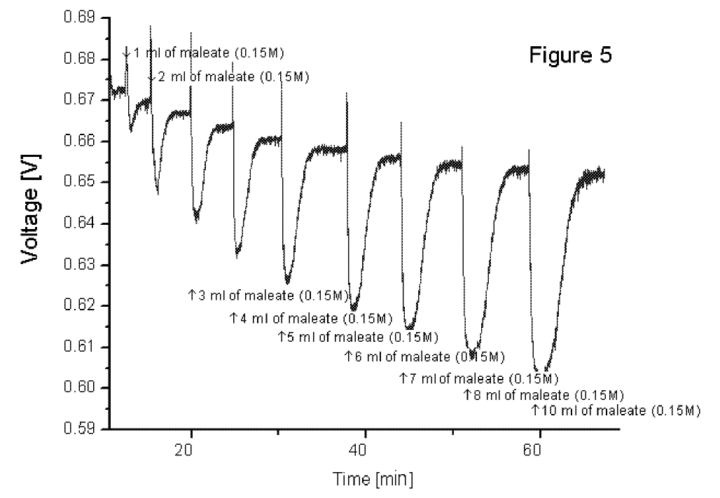

FIG. 5 shows a voltage/time graph for the addition of starting material to a suspension of catalyst C

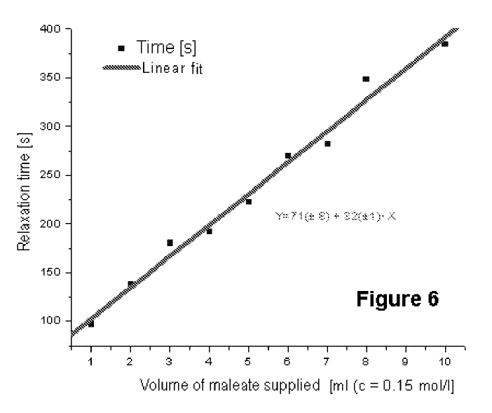

FIG. 6 shows relaxation times for a plurality of starting material additions determined from FIG. 5 as a function of the amount of starting material with linear regression. Characteristic number K2′: gradient of the regression line as characteristic number for the catalyst C

Tab. 3 shows the measured values from the voltage/time graph shown in FIG. 6

FIG. 7 shows a voltage/time graph for the addition of starting material to a suspension of catalyst C after poisoning with traces of ammonia, which is intended to lead to a reduction in the reaction rate

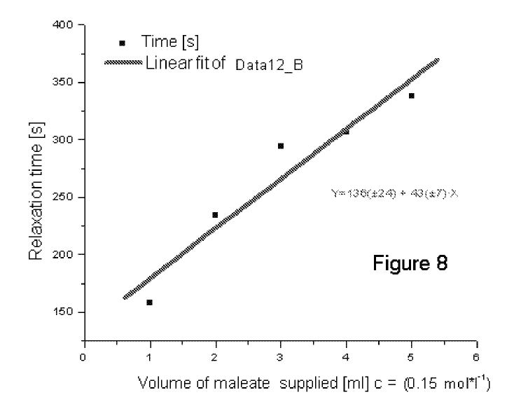

FIG. 8 shows relaxation times for a plurality of starting material additions determined from FIG. 7 as a function of the amount of starting material with linear regression. Characteristic number K2′: gradient of the regression line as characteristic number for the catalyst C after poisoning with ammonia

Tab. 4 the measured values from the voltage/time graph shown in FIG. 8

Tab. 5 the normalized characteristic numbers K1, K2 and K3 determined for the catalysts B, C, and C poisoned

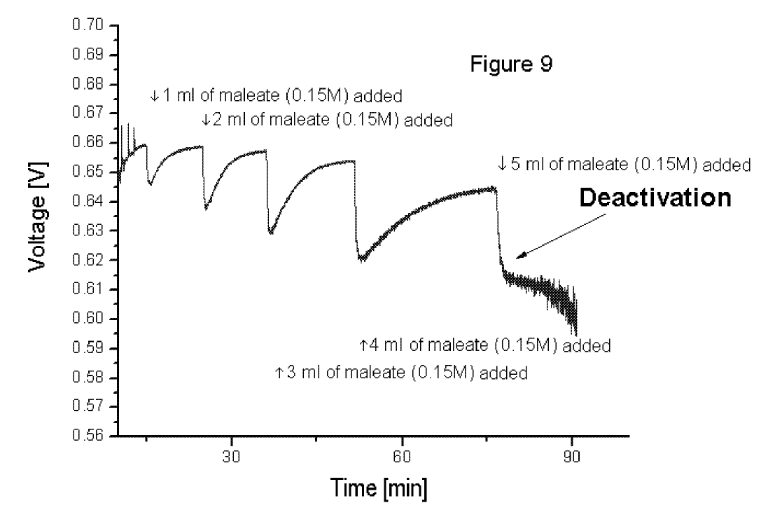

FIG. 9 shows the behavior of the catalyst D when the maximum operating life is exceeded. Characteristic number K4′: sum of the additions in ml of starting material at a defined concentration up to a significant rise in the signal-to-noise ratio for catalyst D

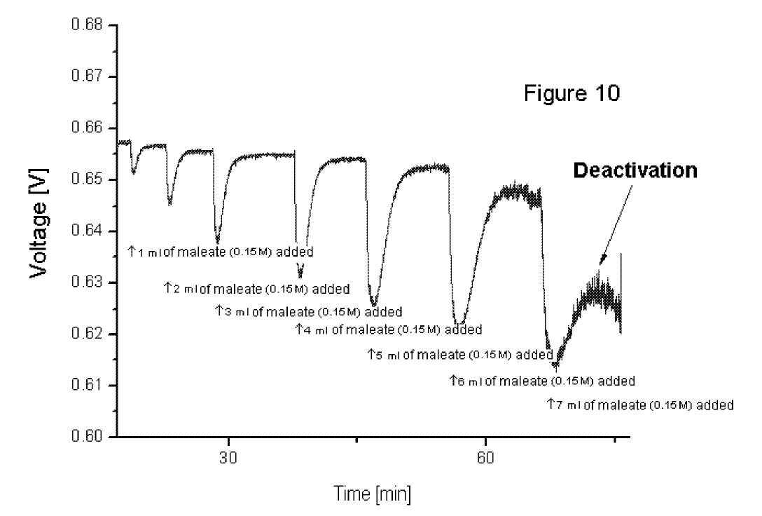

FIG. 10 the behavior of the catalyst E when the maximum operating life is exceeded. Characteristic number K4′: sum of the additions in ml of starting material up to a significant rise in the S/N ratio for catalyst E

Tab. 6 shows the normalized characteristic numbers K4 determined for the catalysts D and E

TABLE 1

| Maleate addition [ml] | Relaxation time [s] |
|---|---|
| 1 | 97 |
| 2 | 138 |
| 3 | 180 |
| 4 | 192 |
| 5 | 222 |
| 6 | 270 |
| 7 | 282 |
| 8 | 348 |
| 10 | 384 |

TABLE 2

| Maleate addition [ml] | Relaxation time [s] |
|---|---|
| 1 | 96 |
| 1.5 | 120 |
| 2 | 150 |
| 2.5 | 164 |
| 3 | 180 |
| 3.5 | 196 |
| 4 | 264 |
| 4.5 | 288 |
| 5 | 348 |
| 8 | 492 |

TABLE 3

| Maleate addition [ml] | Relaxation time [s] |
|---|---|
| 1 | 97 |
| 2 | 138 |
| 3 | 180 |
| 4 | 192 |
| 5 | 222 |
| 6 | 270 |
| 7 | 282 |
| 8 | 348 |
| 10 | 384 |

TABLE 4

| Maleate addition [ml] | Relaxation time [s] |
|---|---|
| 1 | 158 |
| 2 | 234 |
| 3 | 294 |
| 4 | 307 |
| 5 | 338 |

TABLE 5

| | Characteristic | Characteristic | Characteristic |
|---|---|---|---|
| | number K1 | number K2 | number K3 |
| Catalyst | (s * (4 ml)⁻¹ * g⁻¹) | [s * ml⁻¹ * g⁻¹] | [s * g⁻¹] |
| B | 311 | 68 | 28 ± 14 |
| C | 168 | 28 | 62 ± 7 |
| C (poisoned) | 269 | 38 | 119 ± 22 |

TABLE 6

| | Characteristic number K4 |
|---|---|
| Catalyst | [ml * g⁻¹] |
| D | 10 |
| E | 17 |

### EXAMPLES

The potential difference between the gold sheet electrode (power output electrode) dipping into a buffer solution (pH=7) and a calomel electrode (reference electrode) connected in an ionically conductive manner to the solution via a salt bridge was measured under standardized conditions at room temperature, i.e. 22° C., and atmospheric pressure.

FIG. 1 shows, in a voltage/time graph, the changes over time in the potential difference between the reference electrode and the fresh Raney nickel catalyst suspension which is in contact with the power output electrode on successive addition of a 0.15 molar disodium maleate solution to a 0.3 normal K₂HPO₄/NaH₂PO₄ buffer solution. The solution was stirred at 400 rpm of the stirrer and hydrogen was passed through the solution via a glass frit at a volume flow of 10 ml/min. In FIG. 1, the times a) to i) at which disodium maleate solution was added in each case are marked, with the volume being increased by 1 ml from addition to addition (at i) by 2 ml). On addition of the disodium maleate solution, a drop in the absolute voltage to a characteristic minimum and a slow rise in the voltage to a characteristic new voltage level, which is generally close to the initial voltage, is observed. For example, a potential difference 1) for the addition of 8 ml and the relaxation time k) for the addition of 7 ml of disodium maleate solution are indicated.

In FIG. 2, measured relaxation times for a plurality of starting material additions are plotted as a function of the amount of starting material in the experiment described for FIG. 1 with linear regression. a) characteristic number K1′: the relaxation time at a defined amount of added starting material of, in this case, 4 ml, b) characteristic number K2′: gradient of the regression line, c) characteristic number K3′: intercept on the y axis (amount of starting material added=0) of the regression line are indicated. Because some reading errors can occur in the determination of the relaxation time (K1′), it is advisable to use the value K2 obtained after normalization (division) of the value K2′ obtained by the amount of catalyst used as value for comparison of the catalyst activities.

Tab. 1 lists the measured values from the voltage/time graph shown in FIG. 2

FIG. 3 shows, in a voltage/time graph, the changes over time in the potential difference between the reference electrode and the power output electrode; the conditions are selected as described for FIG. 1. A Raney nickel catalyst type B is examined, and disodium maleate addition and evaluation are carried out as described for FIG. 1.

In FIG. 4, measured relaxation times for a plurality of starting material additions are plotted as a function of the amount of starting material in the experiment described for FIG. 3 with linear regression.

Tab. 2 lists the measured values from the voltage/time graph shown in FIG. 4

FIG. 5 shows, in a voltage/time graph, the changes over time in the potential difference between the reference electrode and the power output electrode; the conditions are selected as described for FIG. 1. A Raney nickel catalyst type C is examined, and disodium maleate addition and evaluation are carried out as described for FIG. 1.

In FIG. 6, measured relaxation times for a plurality of starting material additions are plotted as a function of the amount of starting material in the experiment described for FIG. 5 with linear regression.

Tab. 3 lists the measured values from the voltage/time graph shown in FIG. 6

FIG. 7 shows, in a voltage/time graph, the changes over time in the potential difference between the reference electrode and the power output electrode; the conditions are selected as described for FIG. 1. Raney nickel catalyst C after poisoning with traces of ammonia (by addition of 0.5 ml of a 25% strength by weight solution of ammonia in water), which is intended to lead to a reduction in the reaction rate, is examined, and disodium maleate addition and evaluation are carried out as described for FIG. 1.

In FIG. 8, measured relaxation times for a plurality of starting material additions are plotted as a function of the amount of starting material in the experiment described for FIG. 7 with linear regression

Tab. 4 lists the measured values from the voltage/time graph shown in FIG. 8

Tab. 5 shows the characteristic numbers determined and normalized characteristic numbers K1, K2 and K3 for the catalysts B, C and C poisoned. Compared to B, C has a higher activity at room temperature and under atmospheric pressure and otherwise comparable conditions. Compared to C poisoned, C likewise shows a higher activity. The greater the value K2, the lower the activity of the catalyst. The same dependence applies for the characteristic number K1. K3 is a value independent of the addition of starting material and allows a comparative statement about activatability or activation time of the catalyst. The greater this value, the longer the catalyst requires for activation

FIG. 9 shows, in a voltage/time graph, the changes over time in the potential difference between the reference electrode and the power output electrode; the conditions are selected as described for FIG. 1. On addition of a total of more than 10 ml of disodium maleate solution, the behavior of the catalyst D on exceeding the maximum operating life is observed. The signal-to-noise ratio increases sharply and the potential difference no longer reaches the original value; the catalyst is deactivated. Characteristic number K4′: maximum amount of starting material to be added for a defined amount of catalyst before the significant increase in the signal-to-noise ratio

FIG. 10 shows the potential difference between the reference electrode and the power output electrode; the conditions are selected as described for FIG. 1. On addition of a total of more than 21 ml of disodium maleate solution, the behavior of the catalyst E on exceeding the maximum operating life is observed. The behavior of the catalyst E is different from that of the catalyst D in FIG. 9, but is also deactivated. Characteristic number K4′: maximum amount of starting material to be added for a defined amount of catalyst before the significant increase in the signal-to-noise ratio

Tab. 6 shows the characteristic numbers determined and normalized characteristic numbers K4 for the catalysts D and E. The catalyst which can hydrogenate the greatest amount of starting material without the signal-to-noise ratio increasing significantly (in this case catalyst E) has the greater operating life.

1. A method of determining characteristic numbers for catalyst material in suspensions comprising determining a potential difference and the fluctuation and/or change in this difference over time between a measurement electrode which dips into a constantly stirred reaction mixture and a reference electrode.

2. A method for determining the quality of catalysts in a buffered solution, comprising carrying out the method as claimed in claim 1 for determining characteristic numbers of a catalyst, measuring the potential difference caused by addition of starting material and the relaxation time! normalizing the relaxation time (K1) characteristic of a particular amount of added starting material relative to the amount of catalyst used and/or the gradient (K2) relative to the amount of catalyst from a plot of the relaxation time against the amount of starting material added and/or the intercept on the y axis at “amount of starting material supplied=0” (K3) from the abovementioned plot to give a determination of the characteristic numbers.

3. A method for determining the quality of hydrogenation catalysts in a buffered solution, comprising carrying out the method as claimed in claim 1 for determining characteristic numbers of a catalyst, measuring the potential difference caused by addition of starting material and the relaxation time and the maximum possible amount of starting material to be added (K4) for a particular amount of catalyst being determined as characteristic number.

4. The method as claimed in claim 2, wherein one or more quality features (Q1, Q2, etc.) selected from the group consisting of activity, activatability or activation time and operating life are assigned to the characteristic numbers (K1, K2, etc.) determined.

5. The method as claimed in claim 1, wherein metal catalysts either in pure form, doped form, in alloys and/or in mixtures, either supported or unsupported, are used as catalyst material.

6. The method as claimed in claim 1, wherein the reaction mixture is a hydrogenation reaction mixture.

7. The method as claimed in claim 1, wherein the determination of the characteristic numbers is carried out on-line and/or automatically and/or parallelized.

8. A process for producing a product, which comprises using at least one catalyst which has been selected or optimized according to characteristic numbers determined as claimed in claim 1.

9. A process for producing a catalyst, which comprises optimizing the process according to characteristic numbers determined as claimed in claim 1.

10. A method of selecting a catalyst for a defined reaction from a finite number of available catalysts, which comprises making the selection on the basis of characteristic numbers determined as claimed in claim 1.
